(19) United States
(12) Patent Application Publication
(10) Pub. No.: US 2025/0200334 A1
(43) Pub. Date: Jun. 19, 2025

(54) TRACKING MACHINE LEARNING DATA PROVENANCE VIA A BLOCKCHAIN

(71) Applicant: Coinbase, Inc., Oakland, CA (US)

(72) Inventors: Vijay Kodu Dialani, Fremont, CA (US); Rajarshi Gupta, Los Altos, CA (US); Bhaskar Krishnamachari, Los Angeles, CA (US)

(21) Appl. No.: 18/542,399

(22) Filed: Dec. 15, 2023

(51) Int. Cl. G06N 3/0455; G06N 3/084; G06Q 20/36; G06Q 20/38

(52) U.S. Cl. CPC G06N 3/0455; G06N 3/084; G06Q 20/3672; G06Q 20/382; G06Q 20/389

(57) ABSTRACT

Methods, systems, and devices for data management are described. A middleware component may receive, for generating a machine learning model, one or more user inputs associated with the machine learning model and an indication of a data source for training the machine learning model. After receiving the user inputs and the data source, the middleware component may broadcast one or more first blockchain messages that are configured to store first information associated with the one or more user inputs and the data source on a blockchain network. The middleware component may receive input prompts for the machine learning model and one or more responses generated by the machine learning model, and, after receiving the input prompts, broadcast one or more second blockchain messages that are configured to store second information associated with the one or more input prompts and the one or more responses on the blockchain network.

### FIELD OF TECHNOLOGY

The present disclosure relates generally to data management, including techniques for tracking machine learning data provenance via a blockchain.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIGS. 1 and 2 show examples of computing environments that support tracking machine learning data provenance via a blockchain in accordance with aspects of the present disclosure.

FIGS. 3 and 4 show examples of metadata tracking diagrams that support tracking machine learning data provenance via a blockchain in accordance with aspects of the present disclosure.

FIG. 5 shows an example of a process flow that supports tracking machine learning data provenance via a blockchain in accordance with aspects of the present disclosure.

FIG. 6 shows a block diagram of an apparatus that supports tracking machine learning data provenance via a blockchain in accordance with aspects of the present disclosure.

FIG. 7 shows a block diagram of a middleware component that supports tracking machine learning data provenance via a blockchain in accordance with aspects of the present disclosure.

FIG. 8 shows a diagram of a system including a device that supports tracking machine learning data provenance via a blockchain in accordance with aspects of the present disclosure.

FIGS. 9 and 10 show flowcharts illustrating methods that support tracking machine learning data provenance via a blockchain in accordance with aspects of the present disclosure.

### DETAILED DESCRIPTION

Machine learning models, such as large language models (LLMs) may produce outputs based on an input of training data and an input prompt. For example, the training data may be derived from one or more data sources, such as public data sources or private data sources. Further, one or more individuals, such as creators, developers, data scientists, engineers, or other stakeholders may contribute to the development of a machine learning model. For example, an engineer may draft the input prompt used by the machine learning model to produce the output. However, contributions to the machine learning model may not be captured, and, in some cases, the output of the model may not be tied to the contributors. In other words, a provenance of the inputs to the machine learning model—such as the training data and the input prompts—may not be recorded or tied to the output of the model. In some cases, a lack of record for the provenance of the inputs or an association between the inputs and the outputs may prevent a contributor of the machine learning model from establishing ownership of the output or controlling use of the output.

As described herein, a data provenance tracking component may store information associated with creation and use of a machine learning model on a blockchain network. For example, throughout each step of development, deployment, an operation of a machine learning model, the data provenance tracking component may broadcast messages configured to store inputs to the model and outputs of the model on the blockchain network. Additionally, the data provenance tracking component may store an association between the inputs and the outputs. That is, an output stored on the blockchain network may reference one or more inputs also stored on the blockchain network. In some examples, the data provenance tracking component may monitor for use of the outputs. For example, the data provenance component may track use of the outputs, and, in some examples, produce a price estimate or valuation of the output based on frequency of use, a profit generated from the use, or the like. That is, data provenance tracking by the data provenance component may support value attribution for inputs to and outputs of the machine learning model. For example, the data provenance tracking may support accurate valuations of inputs to and outputs of the machine learning model as each step of the development, deployment, and operation of the machine learning model is tracked. These and other techniques are described in further detail with respect to the figures.

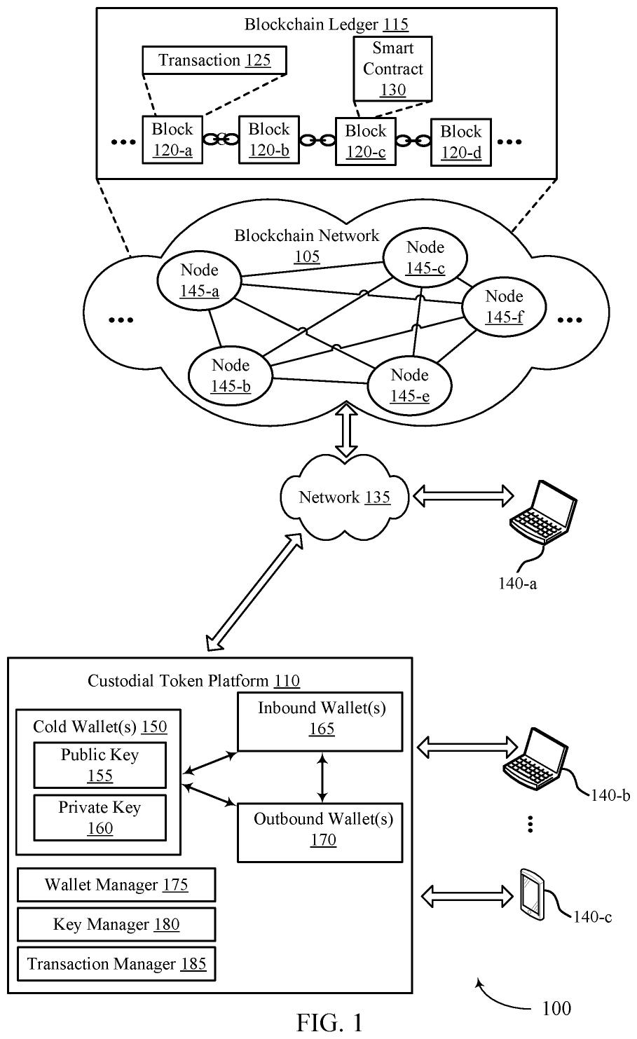

FIG. 1 illustrates an example of a computing environment 100 that supports tracking machine learning data provenance via a blockchain in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the custodial token platform 110, the blockchain network 105, or both. For example, a user of the computing device 140-a may provide user inputs via the computing device 140-a, which may result in commands, data, or any combination thereof being communicated via the network 135 to the custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“DApp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

In some examples, the custodial token platform 110 or another system or service may support one or more machine learning models. For example, the custodial token platform 110 may support a machine learning model which may generate outputs based on training data inputs, user inputs, and/or input prompts. As an example, the machine learning model may generate an NFT. A middleware component associated with the custodial token platform 110 or other system or service may store metadata at each stage of a machine learning model lifecycle on-chain and/or off-chain. For example, the middleware component may broadcast messages on-chain configured to store information (e.g., metadata) from each stage of the machine learning model lifecycle on the blockchain network 105. Additionally, or alternatively, the custodial token platform 110 may support or otherwise be associated with one or more DApps. The one or more DApps may track metadata of the one or more machine learning models. For example, each DApp may track metadata for a different use-case, including model development tracking, data provenance tracking, model input or output digital asset creation and trading, or the like. In some examples, the custodial token platform 110 may determine use of an output of the machine learning models based on the tracking. As an example, the custodial token platform 110 may set a price for an NFT based on supply and demand of the NFT indicated by the tracking.

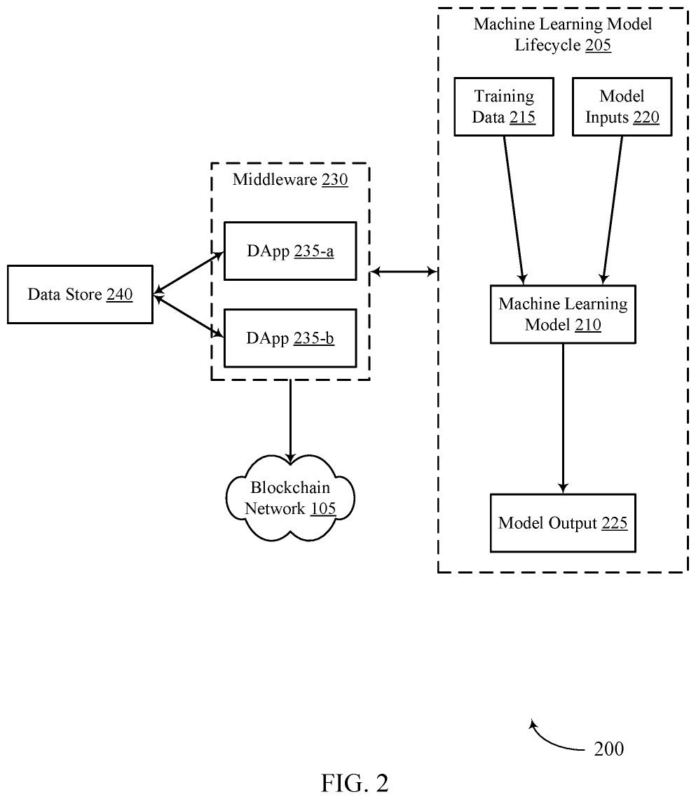

FIG. 2 shows an example of a computing environment 200 that supports tracking machine learning data provenance via a blockchain in accordance with aspects of the present disclosure. The computing environment 200 may include a blockchain network 105 which may be an example of the blockchain network 105 as described with reference to FIG. 1. The computing environment 200 may also include a machine learning model lifecycle 205 including a machine learning model 210, which may be supported by or implemented by a custodial token platform 110 or another system or service as described with reference to FIG. 1.

The machine learning model lifecycle 205 may represent an example of inputs and outputs associated with the machine learning model 210. For example, the machine learning model lifecycle 205 may include training data 215 and model inputs 220 which are input to the machine learning model 210 as well as a model output 225 generated by the machine learning model 210. It may be understood that while the training data 215, model inputs 220, and the model output 225 are illustrated in the example of FIG. 2 as the inputs and outputs of the machine learning model 210, one or more additional inputs, outputs, or both may be included in the machine learning model lifecycle 205 and supported by the data provenance tracking techniques described herein.

In some examples, middleware 230, via one or more DApps including a DApp 235-a and/or a DApp 235-b, may track and store metadata for one or more stages of the machine learning model lifecycle 205. For example, the middleware 230 may receive metadata at each of the one or more stages of the machine learning model lifecycle 205 and store the metadata off-chain, via a data store 240, or on-chain, via the blockchain network 105 using one or more of the DApps 23 and/or other blockchain transactions or messages.

As an example, a generative artificial intelligence (AI) algorithm may be used to generate a digital asset (e.g., a cartoon character image or other content). In some examples, it may be beneficial to determine a proportional asset allocation for each system involved in creation of the digital asset. For example, training data used by the foundational model may bias the algorithm to generate the digital asset based on an input prompt drafted by a prompt engineer. Additionally, or alternatively, a foundational model, prompt engineering, or one or more other contributors to the machine learning model lifecycle 205 may bias the machine learning model 210 to generate the digital asset. By recording a provenance and proof of work, the middleware 230 may attribute creation of an NFT based on the digital asset and the provenance from these records to generate valuations. Additionally, or alternatively, the middleware 230 may support the DApp 235-a and/or the DApp 235-b to provide the NFT for use (e.g., in advertisements, content generation and monetization, branding, etc.). The subsequent derived products generated from the NFT, for example, may be tracked using a provenance mechanism supported by the middleware 230. In other words, the provenance and proof of work may support tracking of a digital economy and use of the tracking for price estimates of the NFT and the digital asset.

To track and store the metadata, the middleware 230 may receive the training data 215, the model inputs 220, or both to the machine learning model 210. For example, a contributor to the machine learning model 210 may input the training data 215, the model inputs 220, or both and these inputs may be captured via the middleware 230. That is, the an inputs for the machine learning model may be captured, received, or obtained by the middleware 230 in order to track and store the metadata. In some other examples, the middleware 230 may be configured to pull the inputs to the machine learning model 210 from the machine learning model lifecycle 205.

The middleware 230 may store information associated with the training data 215, the model inputs 220, or both via the blockchain network 105, via the data store 240, or both. That is, the middleware 230 may store the information on-chain or off-chain. Additionally, or alternatively, the middleware 230 may store a portion of the information on-chain and a portion of the information on-chain. In some examples, the middleware 230 may encrypt the information to be stored via the blockchain network 105, via the data store 240, or both. For example, the middleware 230 may encrypt the information according to a decryption key available to an auditing party, as an example. The information may be encrypted as to prevent personally identifiable information (PII) and/or confidential information from being publicly available on-chain via the blockchain network 105 or off-chain via the data store 240.

Information associated with the model inputs 220 may include user inputs, input prompts, or both. For example, information associated with the user inputs may include a respective identifier for one or more users that created the machine learning model, a description of the machine learning model, documentation associated with the machine learning model, preprocessing parameters, training parameters, one or more timestamps associated with creation of the machine learning model, feature descriptions, model specifications, evaluation metrics, tuning parameters, or the like. Information associated with the input prompts may, similarly, include identifiers for one or more users that created the input prompts, a description of the prompt, documentation associated with the prompt, one or more timestamps associated with creation of the prompt, or the like. Information associated with the training data 215 may include one or more data collection time stamps, data usage agreement information, data source descriptions, or the like. In other words, the information may include indications of how and when each step of the machine learning model lifecycle 205 was performed and/or by whom the step was performed.

Additionally or alternatively from receiving the model inputs, the middleware 230 may receive the model output 225 of the machine learning model 210. For example, the middleware 230 may receive the model output 225 and store information associated with the model output 225 on the blockchain network 105 or at the data store 240. In some examples, the middleware 230 may, together, store the model output 225 and the input prompts. The middleware 230 may encrypt the model output 225 and store an encrypted model output at the blockchain network 105 and/or at the data store 240.

To store the information associated with the training data 215, the model inputs 220, and/or the model output 225 on the blockchain network 105, the middleware 230 may broadcast blockchain messages. For example, the blockchain messages may be configured to store the information associated with the training data 215, the model inputs 220, and/or the model output 225 on the blockchain network. In some examples, the middleware 230 may store the information on-chain via the DApp 235-a and/or the DApp 235-b. For example, the middleware 230 may broadcast messages configured to call a self-executing program supported by the DApp 235-a or the DApp 235-b to store the information. In some examples, the middleware 230 may store different information on-chain via different DApps. In other words, different DApps may support capturing and storing different information related to the machine learning model lifecycle 205. As an example, the DApp 235-a may capture and store, on the blockchain network 105, information associated with inputs to the model while the DApp 235-b may capture and store, on the blockchain network 105, information associated with the model output 225. Additionally, or alternatively, the DApp 235-a and/or the DApp 235 may capture and store the information at the data store 240. The DApps 235 are illustrated as being part of the middleware 230, but it should be understood aspects of the DApps, such as one or more smart contracts, may be implemented on or supported by the blockchain network 105. Thus, the middleware 230 may access aspects of the DApps 235 on the blockchain network to support the techniques described herein. Additionally, the middleware 230 may include aspects for controlling aspects of the DApps 235, such as wallets that are used to manage and configure the smart contracts of the DApps 235.

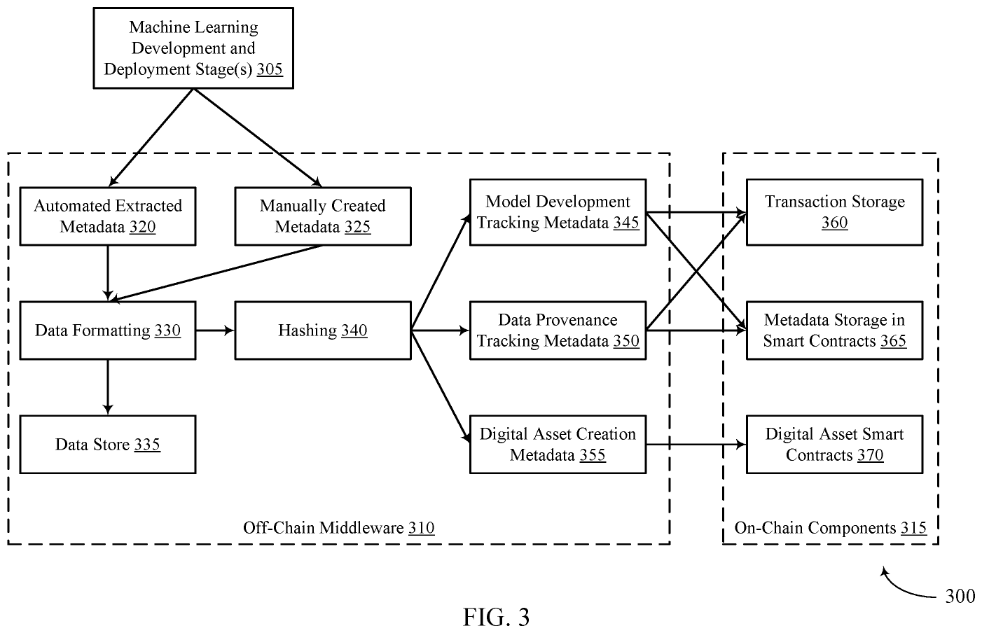

FIG. 3 shows an example of metadata tracking diagram 300 that supports tracking machine learning data provenance via a blockchain in accordance with aspects of the present disclosure. The metadata tracking diagram 300 may include machine learning development and deployment stage(s) 305, off-chain middleware 310, and on-chain components 315. The off-chain middleware 310 may be an example of the middleware 230 as described with reference to FIG. 2. The on-chain components 315 may be on or executed by a blockchain network 105 as described with reference to FIGS. 1 and 2. The machine learning development and deployment stage(s) 305 may be supported by or implemented by a custodial token platform 110 or another system or service as described with reference to FIG. 1.

The machine learning development and deployment stage(s) 305 may include multiple stages, including problem definition; data collection; data pre-processing; feature engineering; model selection; model training; model evaluation; model comparison, hyper-parameter tuning, and optimization; model deployment; model inputs and outputs; and monitoring and maintenance. Each of the machine learning development and deployment stage(s) 305 may be associated with metadata related to a provenance of the machine learning model.

For example, the problem definition stage may include defining a problem to be solved using the machine learning model. The problem definition stage may include evaluating objectives, available data, and/or a target outcome. The metadata at the problem definition stage may include project documentation, stakeholder information, and/or objective descriptions. In some examples, the metadata may be collected manually (e.g., by project managers, data scientists, or machine learning engineers).

The data collection stage may include gathering training data for the machine learning model. For example, the data collection stage may involve collecting data (e.g., new data), identifying datasets (e.g., existing data) and/or obtaining, aggregating, and integrating data from multiple sources. Additionally, or alternatively, the data collection stage may include determining whether the data is representative and relevant to the problem to be solved. In some examples (e.g., supervised learning), the data may include annotations or labels associated with each input. For example, the annotations or labels may be manually or automatically generated. The metadata at the data collection stage may include data source information, collection time stamps, data collector details, data payments, data usage terms, and/or conditions and agreements. In some examples, the metadata may be automatically collected (e.g., via data collection tools) or manually collected (e.g., by data scientists, machine learning engineers, annotators, data owners, and aggregators).

The data pre-processing stage may include preparing the data for analysis and use in training and evaluation. In some examples, the data pre-processing stage may include cleaning the data (e.g., removing duplicates and/or handling missing values), transforming the data into a format (e.g., a suitable or specific format), and/or normalizing numerical values. The metadata at the data preprocessing stage may include preprocessing steps, parameters for pre-processing, time stamps, and/or operator details. In some examples, the metadata may be automatically collected (e.g., via data preprocessing tools) or manually collected (e.g., by data scientists or machine learning engineers).

The feature engineering stage may involve creating and/or selecting features from the data for the machine learning model make predictions or classifications (e.g., accurately). In some examples, the feature engineering stage may involve transforming raw data into one or more features that compactly represent the problem. In some examples, the machine learning development and deployment stage(s) 305 may not include the feature engineering stage. For example, a deep learning algorithm may ingest high dimensional raw data without the feature engineering stage. The metadata at the feature engineering stage may include feature descriptions, generation methods, and/or engineer information. In some examples, the metadata may be automatically collected (e.g., via machine learning libraries) or manually collected (e.g., by data scientists or machine learning engineers).

The model selection stage may include selecting one or more machine learning algorithms to be evaluated and/or compared. For example, the model selection stage may include selecting the machine learning algorithms based on a problem type (e.g., regression, time-series prediction, classification, etc.) and constraints and requirements. The metadata at the model selection stage may include model specifications, selection rationales, selector information, and/or time stamps. In some examples, the metadata may be automatically collected (e.g., via machine learning libraries) or manually collected (e.g., by data scientists or machine learning engineers).

The model training stage may involve training the selected machine learning model on at least a subset of the data, where the subset of the data is a training data set. In some examples, the machine learning model may be trained using an algorithm, such as a backpropagation in the case of neural networks, to determine the model parameters that minimize error with respect to a selected metric. The metadata may include training parameters, training data hashes, trainer details, and/or time stamps at the model training stage. In some examples, the metadata may be automatically collected (e.g., via machine learning libraries).

The model evaluation stage may include assessing a performance of the machine learning model using a subset of the data (e.g., a validation or test set) different than the training data set. In some examples, the model evaluation stage may involve assessing the machine learning model with respect to the selected metric, such as an accuracy, precision, recall, F1 score, or the like. The metadata may include evaluation metrics, evaluation data hashes, and/or evaluator details at the model evaluation stage. In some examples, the metadata may be automatically collected (e.g., via machine learning libraries) or manually collected (e.g., by data scientists or machine learning engineers).

The model comparison, hyper-parameter tuning, and optimization stage may include comparing and selecting one or more machine learning models. For example, different machine learning models may be compared according to the selected metric, and one or more machine learning models may be selected according to the comparison. Additionally, or alternatively, a machine learning model may have hyperparameters related to an architecture (e.g., a quantity of nodes or layers in the case of a neural network) tuned. Hyperparameter tuning may involve use of techniques such as grid or random search to determine a configuration (e.g., an optimized configuration) that is associated with a performance level exceeding a threshold. The metadata may include compared models and results, tuning parameters, optimization methods, and/or tuner details at the model comparison, tuning, and optimization stage. In some examples, the metadata may be automatically collected (e.g., via machine learning libraries) or manually collected (e.g., by data scientists or machine learning engineers).

The model deployment stage may include deploying the trained machine learning model into a production environment. In the production environment, the trained machine learning model may output one or more predications based on data sets (e.g., new data sets). The model deployment stage may involve integrating the machine learning model with one or more existing systems and determining a scalability of the machine learning model. The metadata may include deployment configuration, deployment timestamps, and/or deployer details at the model deployment stage. In some examples, the metadata may be automatically collected (e.g., via deployment tools) or manually collected (e.g., by machine learning operations engineers).

The model inputs and outputs stage may include recording inputs sent to and outputs generated from the machine learning model after deployment. For example, the inputs and outputs may be recorded for inference or classification. In some examples, the inputs may include input prompts, and the outputs may include a generated output from, for example, a generative artificial intelligence (AI) model. The metadata may include input prompts, data, generated outputs, timestamps, and/or generator details at the model inputs and outputs stage. In some examples, the metadata may be automatically collected (e.g., via machine learning libraries, generative AI platforms, or deployment tools).

The monitoring and maintenance stage may include continuously monitoring a performance of the machine learning model. For example, the machine learning model may be continuously or periodically monitored to ensure that it remains accurate and performs as expected and over a time duration. In some examples, the monitoring and maintenance stage may involve updating or retraining the model with new data and addressing errors in an output of the machine learning model observed in the production environment, including scaling up servers to meet demand. The metadata may include performance metrics, update logs, and/or maintainer details at the monitoring and maintenance stage. In some examples, the metadata may be automatically collected (e.g., via monitoring tools) or manually collected (e.g., by data scientists, machine learning engineers, or machine learning operations engineers).

The off-chain middleware 310 may receive metadata, structure the metadata, and store the metadata either off-chain or on-chain. For example, the off-chain middleware 310 may receive automated extracted metadata 320, manually created metadata 325, or both. That is, the off-chain middleware 310 may generate metadata from an automated source in the case of the automated extracted metadata 320 and/or generate metadata from a manual source in the case of the manually created metadata 325. In other words, the off-chain middleware 310 may generate metadata associated with each step of the machine learning development and deployment stage(s) 305.

After receiving the metadata, the off-chain middleware 310 may perform data formatting 330. For example, the off-chain middleware 310 may structure the metadata according to a predefined format or a set or formats. In some examples, a format by which the metadata is structured by the off-chain middleware 310 may be based on a use-case. For example, the format may be based on whether the off-chain middleware 310 is to use the metadata for model development tracking, data provenance tracking, generative AI model input and output based non-fungible digital asset creation, or the like.

The off-chain middleware 310 may, in some examples, store the formatted metadata at a data store 335. For example, the off-chain middleware 310 may store metadata having a size above a threshold at the data store 335 (e.g., high volume data). Additionally, or alternatively, the off-chain middleware 310 may perform hashing 340 on the formatted metadata if the metadata is to be stored on-chain. For example, the off-chain middleware 310 may perform the hashing 340 and/or digital signing to meet a storage threshold (e.g., a storage limitation) and/or facilitate verification of the metadata. In some examples, the off-chain middleware 310 may encrypt the formatted metadata, for example, if the metadata is to be stored on a public blockchain network. For example, the off-chain middleware 310 may encrypt the formatted metadata using a key accessible to an auditing service such that the metadata is verifiable.

The off-chain middleware 310 may store a hash of the metadata or the encrypted metadata via one or more on-chain components 315. For example, the off-chain middleware 310 may store the metadata according to a type of the metadata. In the example of FIG. 3, the off-chain middleware 310 may store model development tracking metadata 345 via transaction storage 360, metadata storage in smart contracts 365, or both; data provenance tracking metadata 350 via the transaction storage 360, the metadata in smart contracts 365, or both; and digital asset creation metadata 355 via digital asset smart contracts 370.

In some examples, such as for the digital asset creation metadata, the off-chain middleware 310 may mint a non-fungible digital asset corresponding to model inputs and outputs.

The off-chain middleware 310 may be implemented as a standalone software tool, integrated into a program (e.g., an existing program), integrated into a machine learning library, implanted as a tool in conjunction with one or more software development tools, or the like.

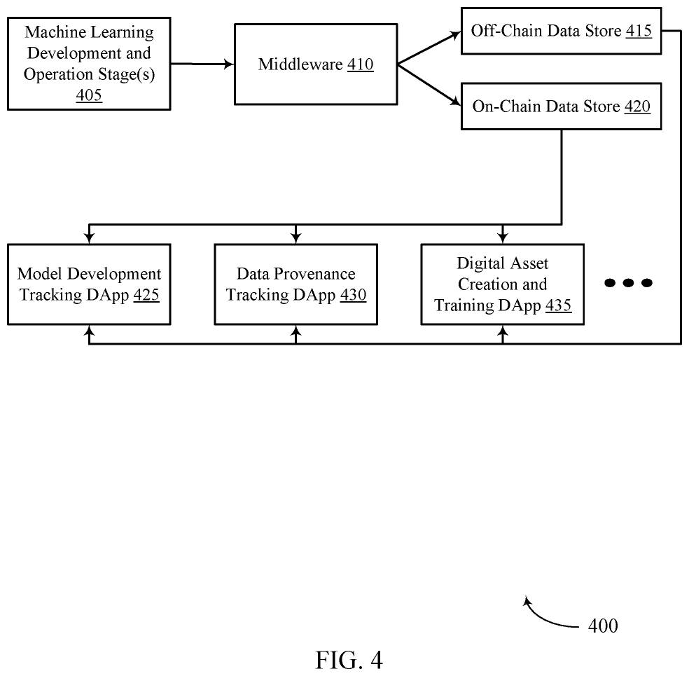

FIG. 4 shows an example of a metadata tracking diagram 400 that supports tracking machine learning data provenance via a blockchain in accordance with aspects of the present disclosure. The metadata tracking diagram 400 may include machine learning development and deployment stage(s) 405, which may be supported by or implemented by a custodial token platform 110 as described with reference to FIG. 1. The middleware 410 may be an example of the middleware 230 as described with reference to FIG. 2 or the off-chain middleware 310 as described with reference to FIG. 3.

The middleware 410, as described with further detail elsewhere herein, including with reference to FIG. 3, may receive metadata, structure metadata, and/or store the metadata in an off-chain data store 415 and/or an on-chain data store 420. The off-chain data store 415 may be an example of the data store 240 or the data store 335 as described with reference to FIG. 2, and FIG. 3, respectively. Additionally, or alternatively, the on-chain data store 420 may refer to data stored on a blockchain network, such as the blockchain network 105 as described with reference to FIGS. 1 and 2.

After the middleware 410 receives, structures, and/or stores metadata, the metadata may be used by one or more DApps. In the example of FIG. 4, DApps using the metadata may include a model development tracking DApp 425, a data provenance tracking DApp 430, and a digital asset creation and training DApp 435.

The model development tracking DApp 425 may facilitate tracking a model development process. For example, the model development tracking DApp 425 may track metadata for each of the machine learning development and operation stage(s) 405. The data provenance tracking DApp 430 may track the provenance of the data used to train a model. For example, the data provenance tracking DApp 430 may track, from the metadata for each of the machine learning development and operation stage(s) 405, data source information, including identifiers of contributors to the data sourcing. The digital asset creation and training DApp 435 may support minting, viewing, trading, and transferring ownership of digital assets corresponding to model inputs (e.g., generative AI prompts, input prompts, etc.) and outputs. In some examples, the digital asset creation and training DApp 435 may track the model inputs and outputs according to weights of the machine learning model.

In some examples, the metadata stored at the off-chain data store 415, the on-chain data store 420, or both may be encrypted. For example, the metadata may be encrypted to protect privacy and/or confidentiality of the data. In such examples, the DApps may have a decryption key for the metadata. That is, the middleware 410 may encrypt the metadata using a key accessible to one or more of the model development tracking DApp 425, the data provenance tracking DApp 430, or the digital asset creation and training DApp 435.

It may be understood that, while three DApps are illustrated and described in the example of FIG. 4, more or less than three DApps and/or DApps of different use-cases may use the metadata stored in the off-chain data store 415 and/or the on-chain data store 420. In other words, the three use-cases illustrated by the example of FIG. 4 represent examples of DApps rather than an exhaustive list of DApps. As an example, another DApp, in addition to or as an alternative of the DApps provided in the example of FIG. 4, may be a digital asset trading platform allowing a user to monetize generative AI prompts along with outputs corresponding to that prompt.

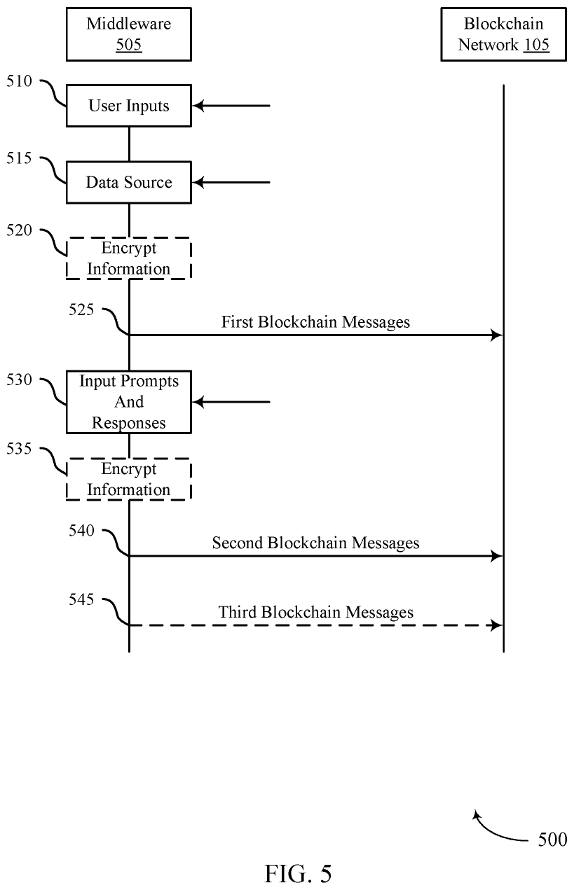

FIG. 5 shows an example of a process flow 500 that supports tracking machine learning data provenance via a blockchain in accordance with aspects of the present disclosure. In some examples, the process flow 500 may implement or be implemented by aspects of the computing environment 100, the computing environment 200, the metadata tracking diagram 300, and the metadata tracking diagram 400 as described with reference to FIGS. 1 through 4. For example, the process flow 500 may include middleware 505, which may be an example of the middleware 230, the off-chain middleware 310, or the middleware 410 as described with reference to FIGS. 2 through 4 and a blockchain network 105 as described with reference to FIGS. 1 and 2.

Alternative examples of the following may be implemented, where some steps are performed in a different order than described or are not performed at all. In some cases, steps may include additional features not mentioned below, or further steps may be added. Although the middleware 505 and the blockchain network 105 are shown performing the operations of the process flow 500, some aspects of some operations may also be performed by one or more other components.

At 510, the middleware 505 may receive one or more user inputs associated with a machine learning model. For example, the middleware 505 may receive the one or more use inputs to generate the machine learning model. In some examples, the one or more user inputs may provide the detailed specification of the machine learning model (e.g., where the machine learning model is previously generated). For example, the machine learning model may be in use (e.g., operational) when the middleware 505 receives the one or more user inputs at 510.

At 515, the middleware 505 may receive an indication of a data source for training the machine learning model. For example, the middleware 505 may receive the indication of the data source for generating the machine learning model.

In some examples, the middleware 505 may receive the one or more user inputs, the indication of the data source, or both at multiple stages of a life cycle of the machine learning model, including problem definition; data collection; data pre-processing; feature engineering; model selection; model training; model evaluation; model comparison, hyper-parameter tuning, and optimization; model deployment; model inputs and outputs; and monitoring and maintenance. For example, the middleware 505 may receive inputs at each of the stages of the machine learning model development and deployment as described in greater detail elsewhere herein, including with reference to FIG. 3.

At 520, the middleware 505 may encrypt at least a portion of first information associated with the one or more user inputs received at 510 and the data source indicated at 515. For example, the middleware 505 may encrypt the portion of the first information to be stored on the blockchain network 105.

At 525, the middleware 505 may broadcast first blockchain messages configured to store the first information associated with the one or more user inputs received at 510 and the data source indicated at 515 on the blockchain network 105. For example, the first information may be encrypted, at least partially, based on the encryption at 520. The first information associated with the one or more user inputs may include a respective identifier for one or more users that created the machine learning model, a description of the machine learning model, documentation associated with the machine learning model, preprocessing parameters, training parameters, one or more timestamps associated with creation of the machine learning model, feature descriptions, model specifications, evaluation metrics, tuning parameters, or the like. Additionally, or alternatively, the first information associated with the data source may include one or more data collection time stamps, data usage agreement information, data source descriptions, or the like.

At 530, the middleware 505 may receive one or more input prompts for the machine learning model and one or more responses generated by the machine learning model.

At 535, the middleware 505 may encrypt at least a portion of second information associated with the one or more input prompts and the one or more responses received at 530. For example, the middleware 505 may encrypt the portion of the second information to be stored on the blockchain network 105.

At 540, the middleware 505 may broadcast second blockchain messages configured to store second information associated with the one or more input prompts and the one or more responses on the blockchain network 105. For example, the second information may be encrypted, at least partially, based on the encryption at 535.

In some examples, the one or more second blockchain messages may be configured to mint an NFT using a self-executing program on the blockchain network 105. For example, the NFT may be associated with one or more responses, inputs to the machine learning model (e.g., input prompts) to the model (e.g., to claim ownership of a particular prompt), or weights or parameters of the machine learning model. For example, the NFT may be associated with one or more aspects of the machine learning model. The NFT may be stored on the blockchain network 105 and reference the first information, the second information, or both.

Restraints on usage of the NFT in content, such as movies, advertisements, etc., (e.g., for brand safety), may be encoded in the or may be accessible based on the NFT. These restraints may be accessed in order to derive value, determine whether the usage violates any rights, or the like. In some examples, the constraints may be programmatically enforced. Additionally, or alternatively, a modified use of the NFT may also be tracked (e.g., on-chain), facilitating revenue attribution. For example, an open and accessible on-chain ledger including use of the NFT, the modified NFT, or both may capture lifetime earnings generated by the NFT.

Additionally, or alternatively, the one or more second blockchain messages may be configured to associate the second information with the first information on the blockchain network 105. In other words, the one or more second blockchain messages may store an output of the machine learning model and reference the information input to the model, the responses from the model, or both.

At 545, the middleware 505 may broadcast one or more third blockchain messages that are configured to store third information associated with use of content associated with the NFT. For example, the third information may define policies or terms guiding use of the NFT.

In some examples, the first blockchain messages, the second blockchain messages, and/or the third blockchain messages may be configured to call a self-executing program on the blockchain network 105 to store the first information, the second information, or the third information. For example, the middleware 505 may store the first information, the second information, or the third information via a DApp that is supported by or is configured to access one or more smart contracts including the self-executing program.

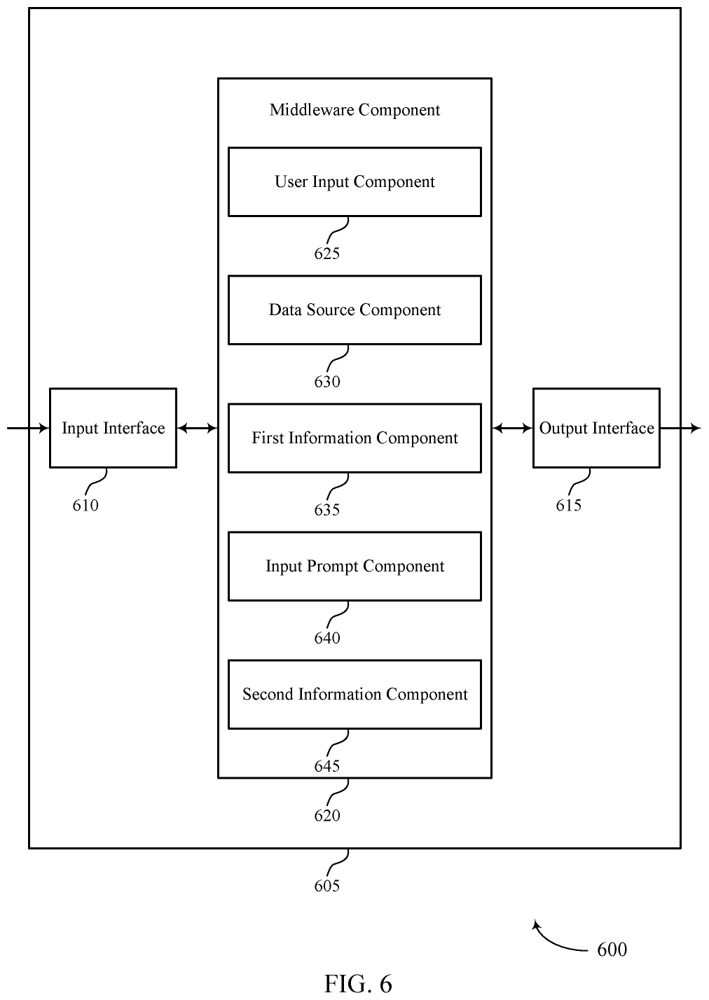

FIG. 6 shows a block diagram 600 of a system 605 that supports tracking machine learning data provenance via a blockchain in accordance with aspects of the present disclosure. The system 605 may include an input interface 610, an output interface 615, and a middleware component 620. The system 605, or one or more components of the system 605 (e.g., the input interface 610, the output interface 615, and the middleware component 620), may include at least one processor, which may be coupled with at least one memory, to support the described techniques. Each of these components may communicate, directly or indirectly, with one another (e.g., via one or more buses, communications links, communications interfaces, or any combination thereof).

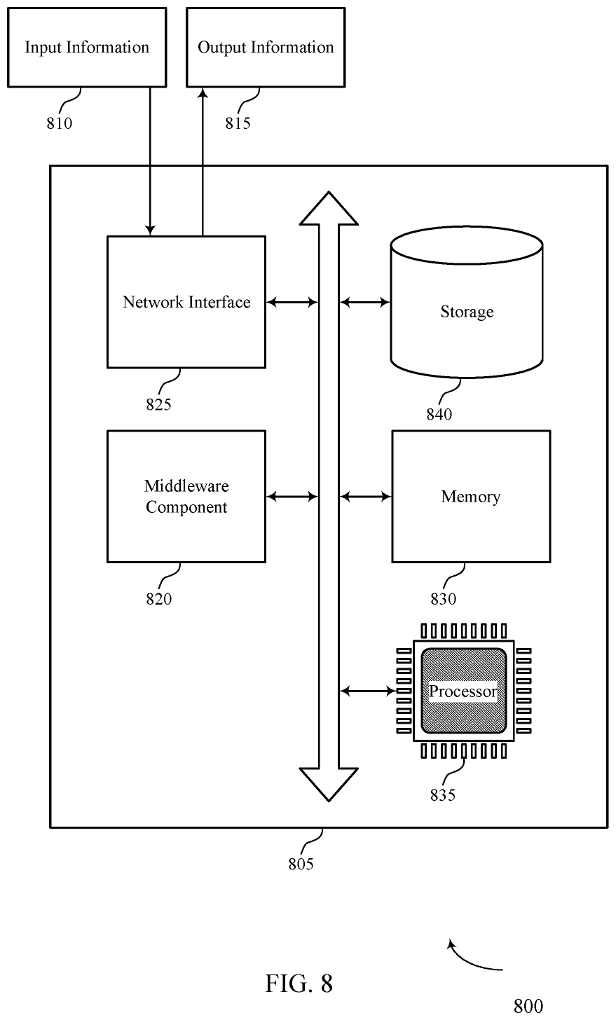

The input interface 610 may manage input signaling for the system 605. For example, the input interface 610 may receive input signaling (e.g., messages, packets, data, instructions, commands, transactions, or any other form of encoded information) from other systems or devices. The input interface 610 may send signaling corresponding to (e.g., representative of or otherwise based on) such input signaling to other components of the system 605 for processing. For example, the input interface 610 may transmit such corresponding signaling to the middleware component 620 to support tracking machine learning data provenance via a blockchain. In some cases, the input interface 610 may be a component of a network interface 825 as described with reference to FIG. 8.

The output interface 615 may manage output signaling for the system 605. For example, the output interface 615 may receive signaling from other components of the system 605, such as the middleware component 620, and may transmit such output signaling corresponding to (e.g., representative of or otherwise based on) such signaling to other systems or devices. In some cases, the output interface 615 may be a component of a network interface 825 as described with reference to FIG. 8.

For example, the middleware component 620 may include a user input component 625, a data source component 630, a first information component 635, an input prompt component 640, a second information component 645, or any combination thereof. In some examples, the middleware component 620, or various components thereof, may be configured to perform various operations (e.g., receiving, monitoring, transmitting) using or otherwise in cooperation with the input interface 610, the output interface 615, or both. For example, the middleware component 620 may receive information from the input interface 610, send information to the output interface 615, or be integrated in combination with the input interface 610, the output interface 615, or both to receive information, transmit information, or perform various other operations as described herein.

The middleware component 620 may support data management in accordance with examples as disclosed herein. The user input component 625 may be configured as or otherwise support a means for receiving, for generating a machine learning model, one or more user inputs associated with the machine learning model. The data source component 630 may be configured as or otherwise support a means for receiving, for generating the machine learning model, an indication of a data source for training the machine learning model. The first information component 635 may be configured as or otherwise support a means for broadcasting one or more first blockchain messages that are configured to store first information associated with the one or more user inputs and the data source on a blockchain network. The input prompt component 640 may be configured as or otherwise support a means for receiving one or more input prompts for the machine learning model and one or more responses generated by the machine learning model. The second information component 645 may be configured as or otherwise support a means for broadcasting one or more second blockchain messages that are configured to store second information associated with the one or more input prompts and the one or more responses on the blockchain network.

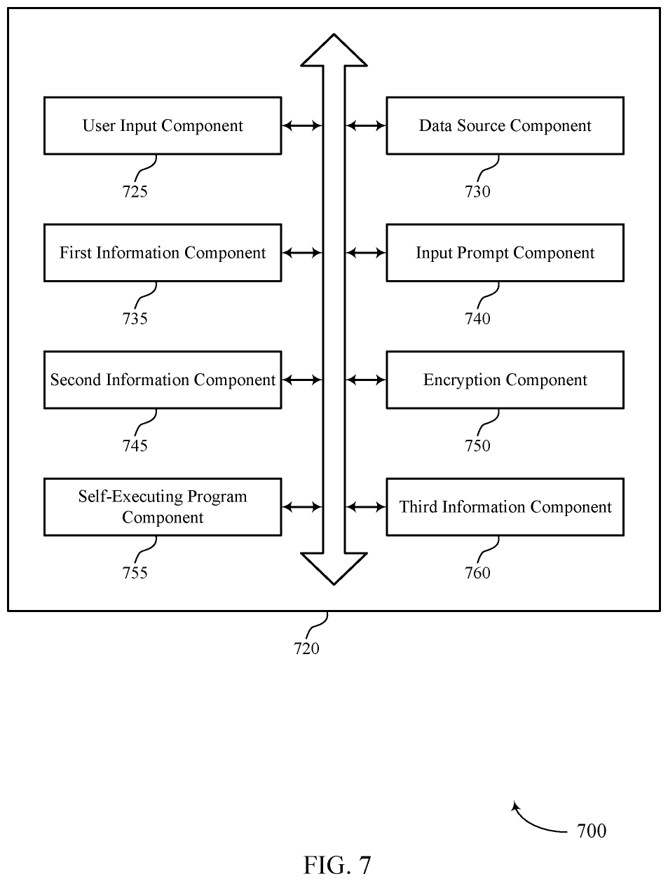

FIG. 7 shows a block diagram 700 of a middleware component 720 that supports tracking machine learning data provenance via a blockchain in accordance with aspects of the present disclosure. The middleware component 720 may be an example of aspects of a middleware component or a middleware component 620, or both, as described herein. The middleware component 720, or various components thereof, may be an example of means for performing various aspects of tracking machine learning data provenance via a blockchain as described herein. For example, the middleware component 720 may include a user input component 725, a data source component 730, a first information component 735, an input prompt component 740, a second information component 745, an encryption component 750, a self-executing program component 755, a third information component 760, or any combination thereof. Each of these components may communicate, directly or indirectly, with one another (e.g., via one or more buses, communications links, communications interfaces, or any combination thereof).

The middleware component 720 may support data management in accordance with examples as disclosed herein. The user input component 725 may be configured as or otherwise support a means for receiving, for generating a machine learning model, one or more user inputs associated with the machine learning model. The data source component 730 may be configured as or otherwise support a means for receiving, for generating the machine learning model, an indication of a data source for training the machine learning model. The first information component 735 may be configured as or otherwise support a means for broadcasting one or more first blockchain messages that are configured to store first information associated with the one or more user inputs and the data source on a blockchain network. The input prompt component 740 may be configured as or otherwise support a means for receiving one or more input prompts for the machine learning model and one or more responses generated by the machine learning model. The second information component 745 may be configured as or otherwise support a means for broadcasting one or more second blockchain messages that are configured to store second information associated with the one or more input prompts and the one or more responses on the blockchain network.

In some examples, to support broadcasting the one or more second blockchain messages, the second information component 745 may be configured as or otherwise support a means for broadcasting the one or more second blockchain messages that are configured to mint a non-fungible token associated with the one or more responses using a self-executing program on the blockchain network, wherein the non-fungible token is stored on the blockchain network and references the first information, the second information, or both the first information and the second information.

In some examples, the third information component 760 may be configured as or otherwise support a means for broadcasting one or more third blockchain messages that are configured to store third information associated with use of content associated with the non-fungible token.

In some examples, the one or more second blockchain messages are configured to associate the second information with the first information on the blockchain network.

In some examples, the first information associated with the one or more user inputs comprises a respective identifier for one or more users that created the machine learning model, a description of the machine learning model, documentation associated with the machine learning model, preprocessing parameters, training parameters, one or more timestamps associated with creation of the machine learning model, feature descriptions, model specifications, evaluation metrics, tuning parameters, or a combination thereof.

In some examples, the first information associated with the data source comprises one or more data collection time stamps, data usage agreement information, data source descriptions, or a combination thereof.

In some examples, the encryption component 750 may be configured as or otherwise support a means for encrypting at least a portion of the first information, the second information, or both to generate encrypted information, wherein the encrypted information is stored on the blockchain network.

In some examples, the one or more first blockchain messages or the one or more second blockchain messages are configured to call a self-executing program on the blockchain network to store the first information, the second information, or both.

FIG. 8 shows a diagram of a system 800 including a system 805 that supports tracking machine learning data provenance via a blockchain in accordance with aspects of the present disclosure. The system 805 may be an example of or include the components of a system 605 as described herein. The system 805 may include components for tracking machine learning data provenance, such as a middleware component 820, an input information 810, an output information 815, a network interface 825, at least one memory 830, at least one processor 835, and a storage 840. Each of these components may communicate, directly or indirectly, with one another (e.g., via one or more buses, communications links, communications interfaces, or any combination thereof).

The network interface 825 may enable the system 805 to exchange information (e.g., input information 810, output information 815, or both) with other systems or devices (not shown). For example, the network interface 825 may enable the system 805 to connect to a network (e.g., a network 135 as described herein). The network interface 825 may include one or more wireless network interfaces, one or more wired network interfaces, or any combination thereof.

Memory 830 may include RAM, ROM, or both. The memory 830 may store computer-readable, computer-executable software including instructions that, when executed, cause at least one processor 835 to perform various functions described herein, such as functions supporting tracking machine learning data provenance via a blockchain. In some cases, the memory 830 may contain, among other things, a basic input/output system (BIOS), which may control basic hardware or software operation such as the interaction with peripheral components or devices. In some cases, the memory 830 may be an example of aspects of one or more components of a custodial token platform 110 as described with reference to FIG. 1. The memory 830 may be an example of a single memory or multiple memories. For example, the system 805 may include one or more memories 830.

The processor 835 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 835 may be configured to execute computer-readable instructions stored in at least one memory 830 to perform various functions (e.g., functions or tasks supporting tracking machine learning data provenance via a blockchain). Though a single processor 835 is depicted in the example of FIG. 8, it is to be understood that the system 805 may include any quantity of one or more of processors 835 and that a group of processors 835 may collectively perform one or more functions ascribed herein to a processor, such as the processor 835. The processor 835 may be an example of a single processor or multiple processors. For example, the system 805 may include one or more processors 835.

Storage 840 may be configured to store data that is generated, processed, stored, or otherwise used by the system 805. In some cases, the storage 840 may include one or more HDDs, one or more SDDs, or both. In some examples, the storage 840 may be an example of a single database, a distributed database, multiple distributed databases, a data store, a data lake, or an emergency backup database. In some examples, the storage 840 may be an example of one or more components described with reference to FIG. 1.

The middleware component 820 may support data management in accordance with examples as disclosed herein. For example, the middleware component 820 may be configured as or otherwise support a means for receiving, for generating a machine learning model, one or more user inputs associated with the machine learning model. The middleware component 820 may be configured as or otherwise support a means for receiving, for generating the machine learning model, an indication of a data source for training the machine learning model. The middleware component 820 may be configured as or otherwise support a means for broadcasting one or more first blockchain messages that are configured to store first information associated with the one or more user inputs and the data source on a blockchain network. The middleware component 820 may be configured as or otherwise support a means for receiving one or more input prompts for the machine learning model and one or more responses generated by the machine learning model. The middleware component 820 may be configured as or otherwise support a means for broadcasting one or more second blockchain messages that are configured to store second information associated with the one or more input prompts and the one or more responses on the blockchain network.

By including or configuring the middleware component 820 in accordance with examples as described herein, the system 805 may support techniques for improved reliability with respect to data provenance tracking and improved security with respect to data storage for metadata related to a machine learning model.

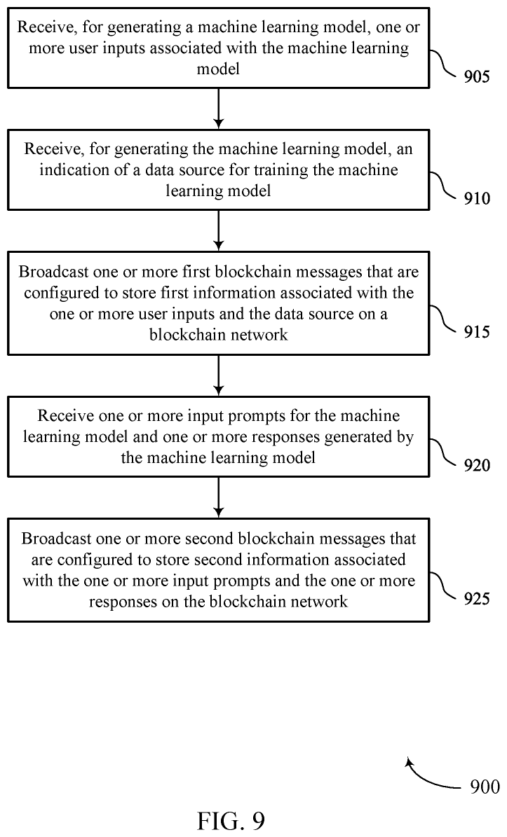

FIG. 9 shows a flowchart illustrating a method 900 that supports tracking machine learning data provenance via a blockchain in accordance with aspects of the present disclosure. The operations of the method 900 may be implemented by a middleware or its components as described herein. For example, the operations of the method 900 may be performed by a middleware as described with reference to FIGS. 1 through 8. In some examples, a middleware may execute a set of instructions to control the functional elements of the middleware to perform the described functions. Additionally, or alternatively, the middleware may perform aspects of the described functions using special-purpose hardware.

At 905, the method may include receiving, for generating a machine learning model, one or more user inputs associated with the machine learning model. The operations of block 905 may be performed in accordance with examples as disclosed herein. In some examples, aspects of the operations of 905 may be performed by a user input component 725 as described with reference to FIG. 7.

At 910, the method may include receiving, for generating the machine learning model, an indication of a data source for training the machine learning model. The operations of block 910 may be performed in accordance with examples as disclosed herein. In some examples, aspects of the operations of 910 may be performed by a data source component 730 as described with reference to FIG. 7.

At 915, the method may include broadcasting one or more first blockchain messages that are configured to store first information associated with the one or more user inputs and the data source on a blockchain network. The operations of block 915 may be performed in accordance with examples as disclosed herein. In some examples, aspects of the operations of 915 may be performed by a first information component 735 as described with reference to FIG. 7.

At 920, the method may include receiving one or more input prompts for the machine learning model and one or more responses generated by the machine learning model. The operations of block 920 may be performed in accordance with examples as disclosed herein. In some examples, aspects of the operations of 920 may be performed by an input prompt component 740 as described with reference to FIG. 7.

At 925, the method may include broadcasting one or more second blockchain messages that are configured to store second information associated with the one or more input prompts and the one or more responses on the blockchain network. The operations of block 925 may be performed in accordance with examples as disclosed herein. In some examples, aspects of the operations of 925 may be performed by a second information component 745 as described with reference to FIG. 7.

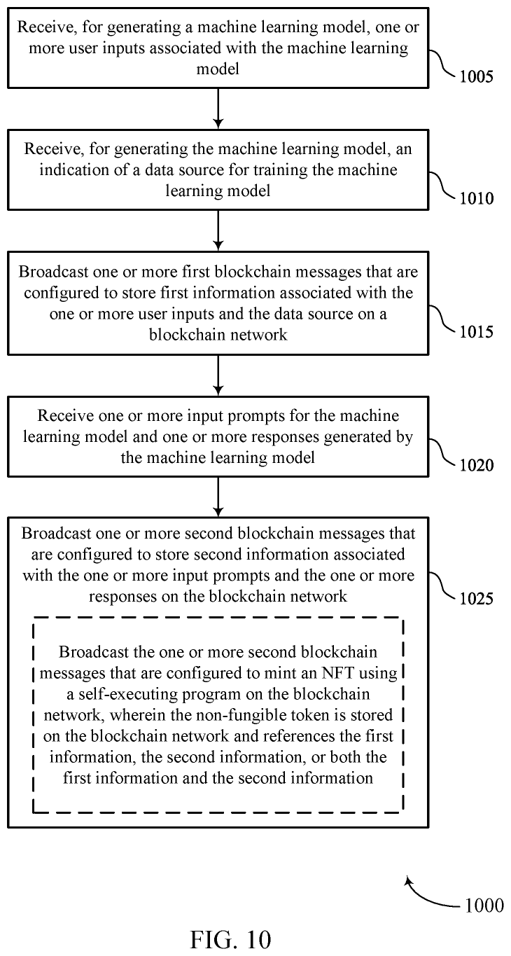

FIG. 10 shows a flowchart illustrating a method 1000 that supports tracking machine learning data provenance via a blockchain in accordance with aspects of the present disclosure. The operations of the method 1000 may be implemented by a middleware or its components as described herein. For example, the operations of the method 1000 may be performed by a middleware as described with reference to FIGS. 1 through 8. In some examples, a middleware may execute a set of instructions to control the functional elements of the middleware to perform the described functions. Additionally, or alternatively, the middleware may perform aspects of the described functions using special-purpose hardware.

At 1005, the method may include receiving, for generating a machine learning model, one or more user inputs associated with the machine learning model. The operations of block 1005 may be performed in accordance with examples as disclosed herein. In some examples, aspects of the operations of 1005 may be performed by a user input component 725 as described with reference to FIG. 7.

At 1010, the method may include receiving, for generating the machine learning model, an indication of a data source for training the machine learning model. The operations of block 1010 may be performed in accordance with examples as disclosed herein. In some examples, aspects of the operations of 1010 may be performed by a data source component 730 as described with reference to FIG. 7.

At 1015, the method may include broadcasting one or more first blockchain messages that are configured to store first information associated with the one or more user inputs and the data source on a blockchain network. The operations of block 1015 may be performed in accordance with examples as disclosed herein. In some examples, aspects of the operations of 1015 may be performed by a first information component 735 as described with reference to FIG. 7.

At 1020, the method may include receiving one or more input prompts for the machine learning model and one or more responses generated by the machine learning model. The operations of block 1020 may be performed in accordance with examples as disclosed herein. In some examples, aspects of the operations of 1020 may be performed by an input prompt component 740 as described with reference to FIG. 7.

At 1025, the method may include broadcasting one or more second blockchain messages that are configured to store second information associated with the one or more input prompts and the one or more responses on the blockchain network. The one or more second blockchain messages may be configured to mint a non-fungible token associated with the one or more responses using a self-executing program on the blockchain network, wherein the non-fungible token is stored on the blockchain network and references the first information, the second information, or both the first information and the second information. The operations of block 1025 may be performed in accordance with examples as disclosed herein. In some examples, aspects of the operations of 1025 may be performed by a second information component 745 as described with reference to FIG. 7.

A method for data management by an apparatus is described. The method may include receiving, for generating a machine learning model, one or more user inputs associated with the machine learning model, receiving, for generating the machine learning model, an indication of a data source for training the machine learning model, broadcasting one or more first blockchain messages that are configured to store first information associated with the one or more user inputs and the data source on a blockchain network, receiving one or more input prompts for the machine learning model and one or more responses generated by the machine learning model, and broadcasting one or more second blockchain messages that are configured to store second information associated with the one or more input prompts and the one or more responses on the blockchain network.

An apparatus for data management is described. The apparatus may include one or more memories storing processor executable code, and one or more processors coupled with the one or more memories. The one or more processors may individually or collectively operable to execute the code to cause the apparatus to receive, for generating a machine learning model, one or more user inputs associated with the machine learning model, receive, for generating the machine learning model, an indication of a data source for training the machine learning model, broadcast one or more first blockchain messages that are configured to store first information associated with the one or more user inputs and the data source on a blockchain network, receive one or more input prompts for the machine learning model and one or more responses generated by the machine learning model, and broadcast one or more second blockchain messages that are configured to store second information associated with the one or more input prompts and the one or more responses on the blockchain network.

Another apparatus for data management is described. The apparatus may include means for receiving, for generating a machine learning model, one or more user inputs associated with the machine learning model, means for receiving, for generating the machine learning model, an indication of a data source for training the machine learning model, means for broadcasting one or more first blockchain messages that are configured to store first information associated with the one or more user inputs and the data source on a blockchain network, means for receiving one or more input prompts for the machine learning model and one or more responses generated by the machine learning model, and means for broadcasting one or more second blockchain messages that are configured to store second information associated with the one or more input prompts and the one or more responses on the blockchain network.

A non-transitory computer-readable medium storing code for data management is described. The code may include instructions executable by one or more processors to receive, for generating a machine learning model, one or more user inputs associated with the machine learning model, receive, for generating the machine learning model, an indication of a data source for training the machine learning model, broadcast one or more first blockchain messages that are configured to store first information associated with the one or more user inputs and the data source on a blockchain network, receive one or more input prompts for the machine learning model and one or more responses generated by the machine learning model, and broadcast one or more second blockchain messages that are configured to store second information associated with the one or more input prompts and the one or more responses on the blockchain network.

In some examples of the method, apparatus, and non-transitory computer-readable medium described herein, broadcasting the one or more second blockchain messages may include operations, features, means, or instructions for broadcasting the one or more second blockchain messages that may be configured to mint a non-fungible token associated with the one or more responses using a self-executing program on the blockchain network, wherein the non-fungible token may be stored on the blockchain network and references the first information, the second information, or both the first information and the second information.

Some examples of the method, apparatus, and non-transitory computer-readable medium described herein may further include operations, features, means, or instructions for broadcasting one or more third blockchain messages that may be configured to store third information associated with use of content associated with the non-fungible token.

In some examples of the method, apparatus, and non-transitory computer-readable medium described herein, the one or more second blockchain messages may be configured to associate the second information with the first information on the blockchain network.

In some examples of the method, apparatus, and non-transitory computer-readable medium described herein, the first information associated with the one or more user inputs comprises a respective identifier for one or more users that created the machine learning model, a description of the machine learning model, documentation associated with the machine learning model, preprocessing parameters, training parameters, one or more timestamps associated with creation of the machine learning model, feature descriptions, model specifications, evaluation metrics, tuning parameters, or a combination thereof.

In some examples of the method, apparatus, and non-transitory computer-readable medium described herein, the first information associated with the data source comprises one or more data collection time stamps, data usage agreement information, data source descriptions, or a combination thereof.

Some examples of the method, apparatus, and non-transitory computer-readable medium described herein may further include operations, features, means, or instructions for encrypting at least a portion of the first information, the second information, or both to generate encrypted information, wherein the encrypted information may be stored on the blockchain network.

In some examples of the method, apparatus, and non-transitory computer-readable medium described herein, the one or more first blockchain messages or the one or more second blockchain messages may be configured to call a self-executing program on the blockchain network to store the first information, the second information, or both.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for data management, comprising:
receiving, for generating a machine learning model, one or more user inputs associated with the machine learning model;
receiving, for generating the machine learning model, an indication of a data source for training the machine learning model;
broadcasting one or more first blockchain messages that are configured to store first information associated with the one or more user inputs and the data source on a blockchain network;
receiving one or more input prompts for the machine learning model and one or more responses generated by the machine learning model; and
broadcasting one or more second blockchain messages that are configured to store second information associated with the one or more input prompts and the one or more responses on the blockchain network.

2. The method of claim 1, wherein broadcasting the one or more second blockchain messages comprises:
broadcasting the one or more second blockchain messages that are configured to mint a non-fungible token using a self-executing program on the blockchain network, wherein the non-fungible token is stored on the blockchain network and references the first information, the second information, or both the first information and the second information.

3. The method of claim 2, further comprising:
broadcasting one or more third blockchain messages that are configured to store third information associated with use of content associated with the non-fungible token.

4. The method of claim 1, wherein the one or more second blockchain messages are configured to associate the second information with the first information on the blockchain network.

5. The method of claim 1, wherein the first information associated with the one or more user inputs comprises a respective identifier for one or more users that created the machine learning model, a description of the machine learning model, documentation associated with the machine learning model, preprocessing parameters, training parameters, one or more timestamps associated with creation of the machine learning model, feature descriptions, model specifications, evaluation metrics, tuning parameters, or a combination thereof.

6. The method of claim 1, wherein the first information associated with the data source comprises one or more data collection time stamps, data usage agreement information, data source descriptions, or a combination thereof.

7. The method of claim 1, further comprising:
encrypting at least a portion of the first information, the second information, or both to generate encrypted information, wherein the encrypted information is stored on the blockchain network.

8. The method of claim 1, wherein the one or more first blockchain messages or the one or more second blockchain messages are configured to call a self-executing program on the blockchain network to store the first information, the second information, or both.

9. An apparatus for data management, comprising:
one or more memories storing processor-executable code; and
one or more processors coupled with the one or more memories and individually or collectively operable to execute the code to cause the apparatus to:
receive, for generating a machine learning model, one or more user inputs associated with the machine learning model;
receive, for generating the machine learning model, an indication of a data source for training the machine learning model;
broadcast one or more first blockchain messages that are configured to store first information associated with the one or more user inputs and the data source on a blockchain network;
receive one or more input prompts for the machine learning model and one or more responses generated by the machine learning model; and
broadcast one or more second blockchain messages that are configured to store second information associated with the one or more input prompts and the one or more responses on the blockchain network.

10. The apparatus of claim 9, wherein, to broadcast the one or more second blockchain messages, the one or more processors are individually or collectively operable to execute the code to cause the apparatus to:
broadcast the one or more second blockchain messages that are configured to mint a non-fungible token using a self-executing program on the blockchain network, wherein the non-fungible token is stored on the blockchain network and references the first information, the second information, or both the first information and the second information.

11. The apparatus of claim 10, wherein the one or more processors are individually or collectively further operable to execute the code to cause the apparatus to:
broadcast one or more third blockchain messages that are configured to store third information associated with use of content associated with the non-fungible token.

12. The apparatus of claim 9, wherein the one or more second blockchain messages are configured to associate the second information with the first information on the blockchain network.

13. The apparatus of claim 9, wherein the first information associated with the one or more user inputs comprises a respective identifier for one or more users that created the machine learning model, a description of the machine learning model, documentation associated with the machine learning model, preprocessing parameters, training parameters, one or more timestamps associated with creation of the machine learning model, feature descriptions, model specifications, evaluation metrics, tuning parameters, or a combination thereof.

14. The apparatus of claim 9, wherein the first information associated with the data source comprises one or more data collection time stamps, data usage agreement information, data source descriptions, or a combination thereof.

15. The apparatus of claim 9, wherein the one or more processors are individually or collectively further operable to execute the code to cause the apparatus to:
encrypt at least a portion of the first information, the second information, or both to generate encrypted information, wherein the encrypted information is stored on the blockchain network.

16. The apparatus of claim 9, wherein the one or more first blockchain messages or the one or more second blockchain messages are configured to call a self-executing program on the blockchain network to store the first information, the second information, or both.

17. A non-transitory computer-readable medium storing code for data management, the code comprising instructions executable by one or more processors to:
receive, for generating a machine learning model, one or more user inputs associated with the machine learning model;
receive, for generating the machine learning model, an indication of a data source for training the machine learning model;
broadcast one or more first blockchain messages that are configured to store first information associated with the one or more user inputs and the data source on a blockchain network;
receive one or more input prompts for the machine learning model and one or more responses generated by the machine learning model; and
broadcast one or more second blockchain messages that are configured to store second information associated with the one or more input prompts and the one or more responses on the blockchain network.

18. The non-transitory computer-readable medium of claim 17, wherein the instructions to broadcast the one or more second blockchain messages are executable by the one or more processors to:
broadcast the one or more second blockchain messages that are configured to mint a non-fungible token using a self-executing program on the blockchain network, wherein the non-fungible token is stored on the blockchain network and references the first information, the second information, or both the first information and the second information.

19. The non-transitory computer-readable medium of claim 18, wherein the instructions are further executable by the one or more processors to:
broadcast one or more third blockchain messages that are configured to store third information associated with use of content associated with the non-fungible token.

20. The non-transitory computer-readable medium of claim 17, wherein the one or more second blockchain messages are configured to associate the second information with the first information on the blockchain network.
